(19) United States
(12) Patent Application Publication
(10) Pub. No.: US 2008/0141569 A1
(43) Pub. Date: Jun. 19, 2008

(54) Structure having a wrap and method of wrapping said structure

(76) Inventor: Mark T. Reyland, West Chester, OH (US)

Correspondence Address: Mark F. Smith, 905 Ohio Pike, Cincinnati, OH, 45245, US

(21) Appl. No.: 11/805,807

(22) Filed: May 24, 2007

Related U.S. Application Data
(60) Provisional application No. 60/874,799, filed on Dec. 14, 2006.

(51) Int. Cl. G09F 21/04; G09F 13/22

(52) U.S. Cl. 40/544; 40/590; 40/455; 40/596

(57) ABSTRACT

The present invention is a structure having a new and improved wrap for structures formed from a flexible film that increases the awareness and impact of the wrap. The wrap comprises a background and one or more design elements. In a preferred embodiment of the invention, the design element is a three-dimensional design element that extends in a direction outwardly away from the surface of the structure. In another preferred embodiment the design element comprises an electrolminescent light panel

### TECHNICAL FIELD

This invention relates to wraps, such as for structures, vehicles, and the like are covered with large decals for use in advertising.

### BACKGROUND

Wraps, such as vehicle wraps, whereby structures, vehicles and the like are covered with large decals are now being used in place of more expensive custom painting for many advertising projects. Businesses are finding that such wraps are an efficient and effective to attract new customers. It has been estimated that more than 95% of Americans travel by automobile each week and a vehicle wrap operates like a giant billboard and can generate more than 30,000 impressions each day.

Wraps for vehicles have been used for advertising since the mid-1990's for busses and have recently became more popular for use on other vehicles such as delivery trucks, vans, and automobiles. In addition, structures, such as amusement ride structures, water towers, sides of buildings, and the like have started to use wraps in place of customized painting.

Wraps, in addition to being able to cover, must be weather resistant to heat, cold, ultraviolet light, and wind. In addition, for use as a vehicle wrap, it must be resistant to relatively severe air flow generated by the movement of the vehicle and will not peel off, when exposed to outside forces, such as those produced by a car wash, before it is purposely pulled off. Further, the wrap must be capable of being easily removed without damaging the underlying surface of the structure.

As wraps, such as vehicle wraps, become more common, advertisers are seeking new methods and systems for increasing the awareness and impact that the wrap will have on potential customers. Accordingly, a need exists for a structure having a wrap that is effective for improving the awareness and impact on potential customers.

### DISCLOSURE OF THE INVENTION

The present invention is a structure having a new and improved wrap formed from a flexible film that increases the awareness and impact of the wrap. The wrap comprises a background and one or more design elements. In a preferred embodiment of the invention, the design element is a three-dimensional design element that extends in a direction outwardly away from the surface of the structure.

In another preferred embodiment of the invention the three-dimensional design element is formed from a thermoplastic material.

In another preferred embodiment of the invention the three-dimensional design element includes backing for providing additional structural support to the design element.

In another preferred embodiment of the invention the design element comprises an electrolminescent light panel.

In another preferred embodiment of the invention the design element is a three-dimensional design element having an electrolminescent light panel for providing background lighting to the three-dimensional design element.

In another preferred embodiment of the invention the design element comprises a self-contained electronic sound-emitting device for providing recorded sounds.

In another preferred embodiment of the invention the sound-emitting device comprises an activation device having a motion detector that activates the sound-emitting device when motion of an object is detected within a predetermined proximity or activation zone of the structure.

In another preferred embodiment of the invention the activation device is a timer that activates the sound-emitting device at a fixed or at variable intervals of time.

In another preferred embodiment of the invention the design element is attached to the surface of the structure such that the background of the wrap provides a weather proof seal along the periphery of the design element.

Another preferred embodiment of the invention is a method of installing a wrap on a structure comprising the steps of measuring the structure to form a template, preparing a design having an image (background and design elements) that is sized to properly fit onto the structure, printing a design on the wrap, attaching the wrap to the structure, and installing the design elements such that the background forms a seal around the periphery of the design element.

In another preferred embodiment the method includes the step of forming a three-dimension design element.

In another preferred embodiment of the invention further comprises the step of forming a three-dimensional design element using a vacuum forming process.

In another preferred embodiment of the invention the method includes the step of placing the periphery edges of the background such that they overlap and substantially cover the periphery of each design element.

### BRIEF DESCRIPTION OF THE DRAWINGS

Features, aspects, advantages, and additional embodiments of the present invention will become better understood with regard to the following description, appended claims, and accompanying drawings where:

FIG. 1 is a schematic illustration of a structure, such as a conventional automobile door as shown, having a conventional two-dimensional prior art wrap applied thereon;

FIG. 2 is a partial cross-sectional schematic illustration of a two-dimensional prior art wrap such as shown in FIG. 1;

FIG. 3 is an exploded partial cross-sectional schematic illustration of a preferred embodiment of the subject invention showing a portion of a structure having a wrap applied thereon illustrating a three-dimensional design element;

FIG. 4 is a partial cross-sectional schematic illustration of the portion of the structure having a wrap applied thereon illustrating the three-dimensional design element of FIG. 3;

FIG. 5 is a schematic illustration of a structure showing another preferred embodiment of the invention showing a wrap applied thereon, the wrap having a design element comprising a light panel;

FIG. 6 is a cross-section schematic illustration of the light panel of FIG. 5;

FIG. 7 is an exploded partial cross-sectional schematic illustration showing a portion of the wrap having a design element comprising the light panel of FIG. 5 applied to the surface of the structure;

FIG. 8 is a partial cross-sectional schematic illustration of the wrap of FIG. 7 applied to the surface of the structure;

FIG. 9 is an exploded partial cross-sectional schematic illustration of another preferred embodiment of the invention wherein the light panel comprises a magnetic backing for attaching the design element to the surface of the structure;

FIG. 10 is a partial cross-sectional schematic illustration of the wrap of FIG. 9 attached to a structure;

FIG. 11 is an exploded cross-sectional schematic illustration of another preferred embodiment of the present invention showing a structure having a wrap applied thereon wherein the wrap includes a three-dimensional design element comprising a light panel;

FIG. 12 is a cross sectional schematic illustration of the embodiment of FIG. 11 showing the design element attached to the surface of the structure;

FIG. 13 is a cross-sectional schematic illustration of another preferred embodiment of the invention showing a design element comprising an electronic sound-emitting device;

FIG. 14 is a cross-sectional schematic illustration of the wrap of FIG. 13 attached to a structure;

FIG. 15 is a flowchart representation illustrating the general methodology of how a structure is wrapped utilizing the design elements of the present invention.

### BEST MODE FOR CARRYING OUT THE INVENTION

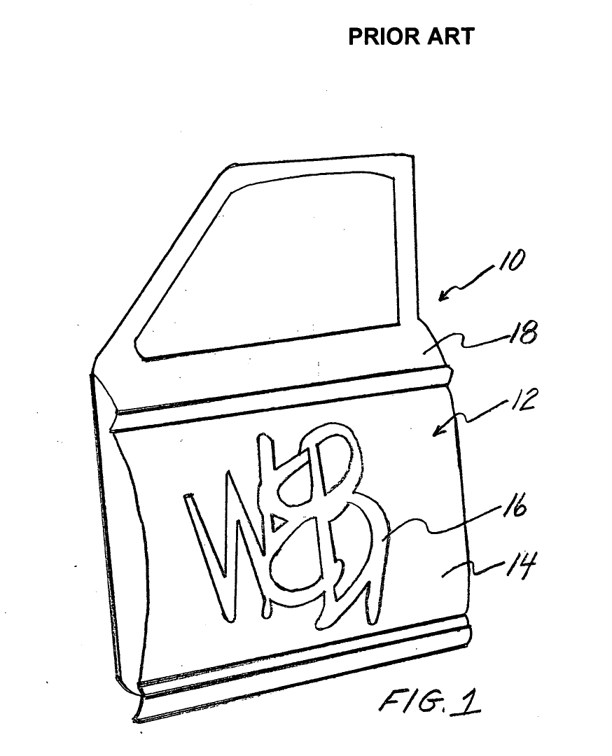

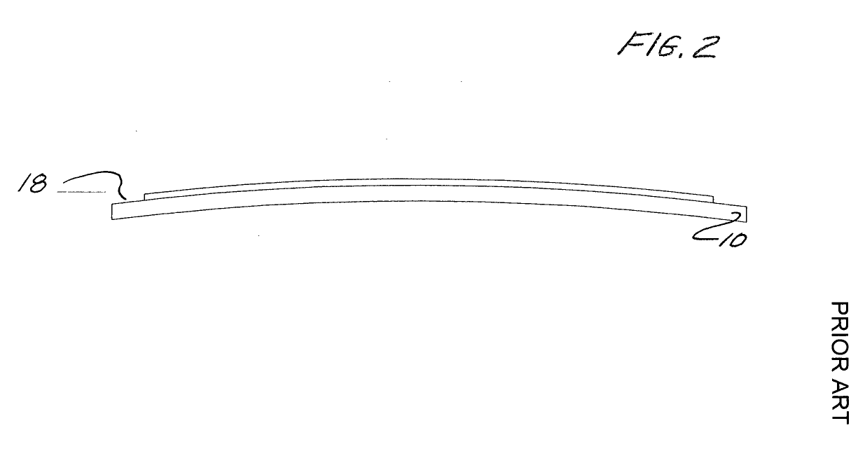

The present invention is a structure having a new and improved wrap that increases the awareness and impact of the wrap and provides a distinct advance in the state of the art. Referring to FIGS. 1 and 2, a structure 10 is shown, such as a portion of a convention automobile, having a conventional wrap 12 applied thereto. As illustrated, the wrap 12 comprises a background 14 and one or more design elements 16, such as logos, lettering, designs, and the like forming a two-dimensional wrap applied to the surface 18 of the structure 10 by use of an adhesive.

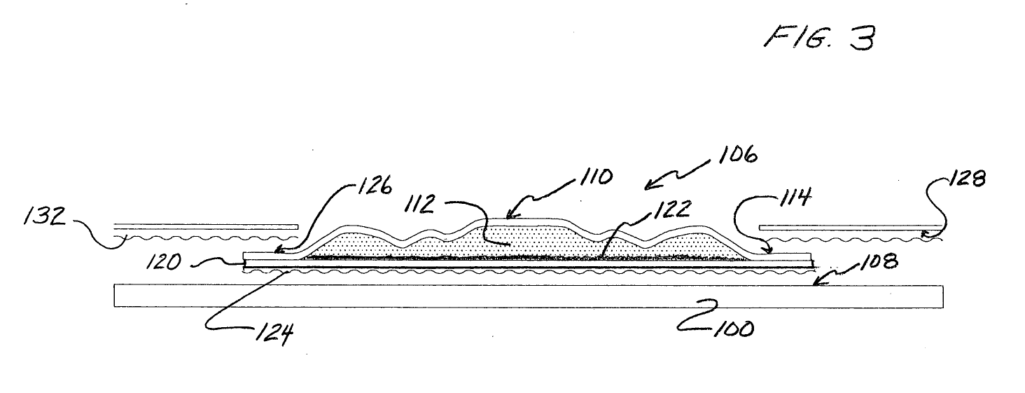

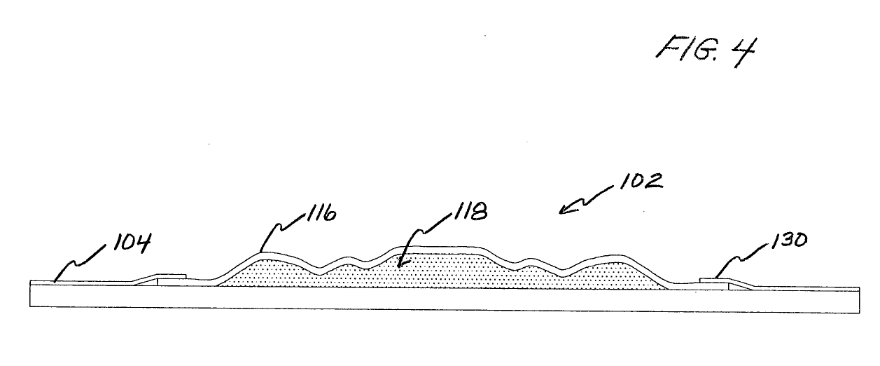

Referring to FIGS. 3 and 4, a preferred embodiment of the invention is shown whereby a structure 100 is shown having a wrap 102 applied thereon. As shown, the wrap 102 comprises a background 104 and one or more design elements 106. In this preferred embodiment, as shown, the design element is a three-dimensional design element that extends in a direction outwardly from the surface 108 of the structure 100.

Preferably, the background 104 of the wrap 102 is formed from a relatively thin opaque vinyl film generally used for wraps. Typically, the film is a cast film that provides a relatively thin film having good durability and conformability characteristics thus providing a “paint-like” finish. However, it should be understood that calendered films that are relatively less expensive than cast films but generally do not have as good of performance characteristics as cast films, may also be used for certain wrap applications. Such films are also well known in the industry. One such pressure-sensitive vinyl film effective for use as a wrap is know as JT5529 sold by MACtac of Stow, Ohio. Another vinyl film comprising a perforated see-through mesh that may be used for covering window areas is known as IMAGIN JT5915SP and is also sold by MACtac.

FIGS. 3 is an exploded cross-sectional schematic illustration a preferred embodiment of one of the design elements 106 of the wrap 102 for attaching to the surface 108 of a structure 100, as shown in FIG. 4. The design element 106 comprises a three-dimensional shape comprising a first surface 110 raised and extending in a direction outwardly from the surface 108 of the structure 100 forming an inner cavity 112 and a relatively flat periphery 114 extending around the first surface 110. Preferably, the design element 106 comprises thermoplastic material such as a relatively thin thermoplastic sheet 116 that has been formed into a three-dimensional shape preferably through the application of heat and pressure such as by a conventional vacuum forming process. During the vacuum forming process, the thermoplastic sheet is heated until it becomes pliable and is placed over or in a tool having the contour for forming the shape of the desired design element. The heated thermoplastic sheet is then drawn by a vacuum until it takes on the shape of the contour of the tool thereby forming the desired shape of the design element.

As shown, the design element 106 may be provided with backing 118 which is effective for filling the cavity 112 and providing additional support for the design element 106. It should now be understood that preferably the backing 118 is a foam padding is formed from a 2.5 lb density expandable 2 part foam, but it should be understood to those skilled in the art that any foam or relatively light filler material that is effective for supporting the three-dimensional design element 106 to maintain its contour and which is capable of withstanding the environment, such as temperature, humidity, and use, that the wrap will be subjected to can be utilized.

It should also be understood that while the design element in this preferred embodiment preferably comprises a thermoplastic material. It should be understood that the design element can be formed from other relatively light-weight materials, such as various types of plastic, capable of withstanding the environment that the structure will be exposed to during operation. In addition, other filler materials may be used to add support to the design element including various types of plastic may be used to provide structural support to the three-dimensional design element.

As shown in FIGS. 3 and 4, the design element 106 of the subject application is preferably attached to a backing sheet 120, such as a vinyl sheet, by an adhesive 122 which is attached to the surface 108 of the structure 100 by an adhesive 124. It should be understood that the adhesives used herein are preferably those typically used for wrap applications. One such adhesive found to be suitable is sold by 3M Company under the name CONTROLTAC™. The background 104 is then applied such that it overlaps and substantially covers the periphery 114 of the first surface 110 of the design element 106. The upper surface 126 of the periphery 114 is then attached to the lower surface 128 of the peripheral edges 130 of the background 104 by an adhesive 132.

It should now be apparent that by the overlapping of the peripheral edges 130 of the background 104 of the wrap 102 onto the periphery 114 of the design element 106 helps to provide a secure attachment of the design element 106 to the surface 108 of the structure 100 and reduces or eliminates the possibility that rain, moisture, or air movement, such as that caused by wind or movement of the surface of the structure 100 (movement of the vehicle) will penetrate under the design element 106 causing it to detach from the surface 108 of the structure 100. It should also now be apparent that by overlapping the peripheral edges 130 of the background 104 onto the periphery 114 of the design element 106 reduces the appearance of any seams and whereby the design elements blend and cooperate with the background to create a harmonized ornamental design.

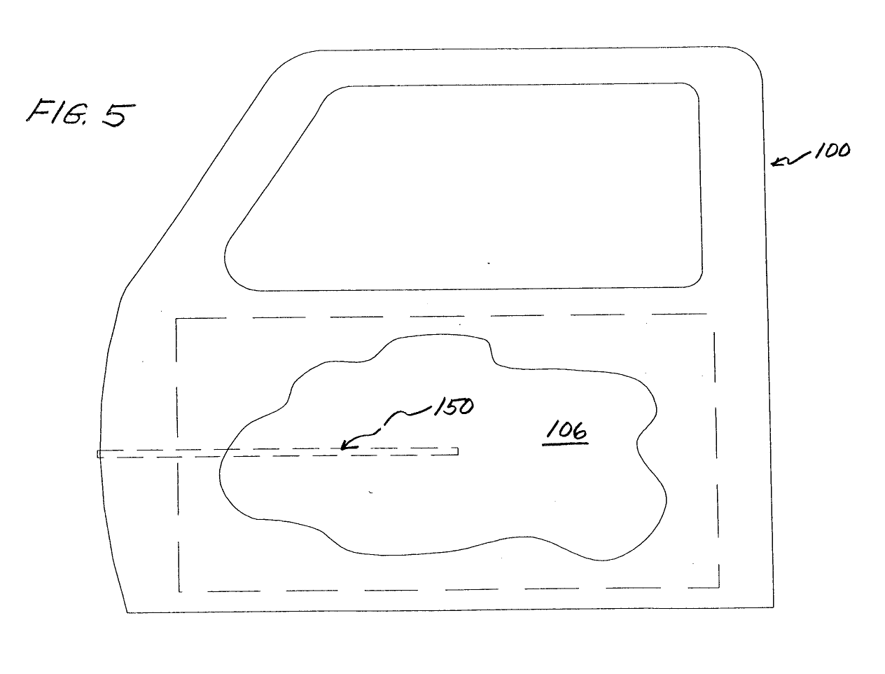

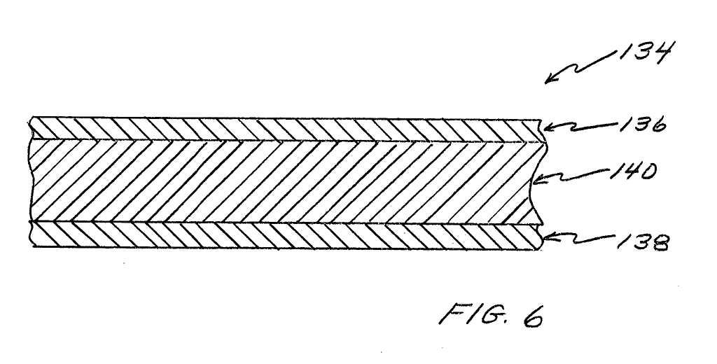

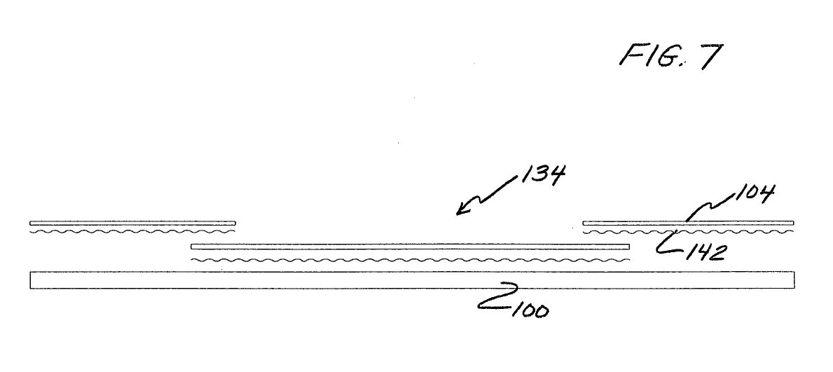

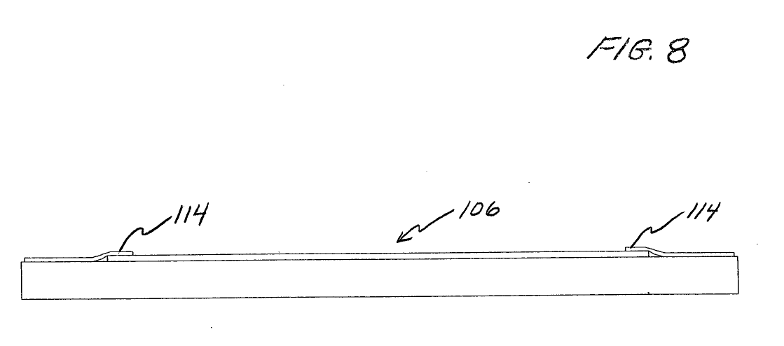

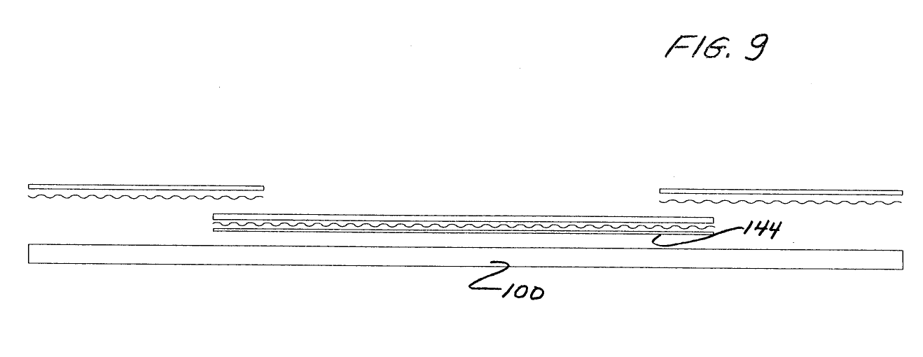

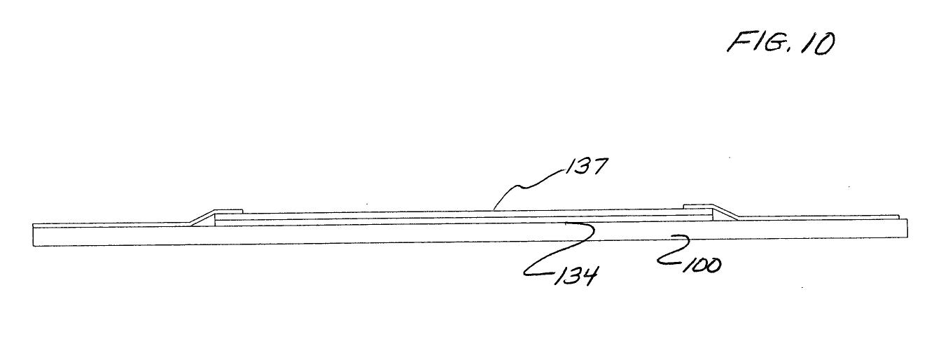

In another preferred embodiment of the invention one or more of the design elements 106 comprises an electroluminescent light panel 134, as shown in FIGS. 5, 6, 7 and 8. Preferably, the electroluminescent light panel 134 is conventionally formed having an upper light permeable electrode layer 136 and a lower electrode layer 138 with a luminescent layer 140 interposed therebetween such that when placed in position on the structure 100 the luminescent layer 140 generates light when excited by an electric current which is then radiated outwardly through the outwardly facing upper light permeable electrode layer 136. One such electroluminescent light panel is shown and described in U.S. patent application Ser. No. 09/815,077 (Publication no. US2002/0011786 A1). As shown, the periphery edges 130 of the background 104 are then placed such that they overlap the periphery 114 of the light panel 134 of each design element 106 and are attached to the thereto by a suitable adhesive 142. In another preferred embodiment, the lower electrode layer 138 can be provided with a magnetic backing 144 such as shown in FIGS. 9 for attaching to certain metallic surfaces of a structure 100. As shown, in another preferred embodiment the light permeable electrode layer 136 can be painted or have a printed surface thereon for adding to the ornamental appearance of the wrap. It should be understood that other electroluminescent light panels that are relatively thin can also be utilized for providing the design element. In another preferred embodiment of the invention, the wrap is applied such that the background fully covers the electroluminescent light panel of the design element. It should be understood that in this embodiment the vinyl film is formed from a translucent material such that the electroluminescent light panel provides backlighting specific areas of the wrap thereby enhancing the wrap's ornamental appearance. Referring to FIG. 10, another preferred embodiment of the invention is shown whereby the light panel 134 is covered by a UV protective transparent sheet of material 137 for providing additional protection against deterioration caused by exposure to ultra-violet light. In a preferred embodiment of the invention, the light panels operate such that specific areas of the light panel can energize or not energize (light-up or not light-up), such as by use of a conventional timing circuit. It should also be understood that the light panel having a design thereon can operate whereby specific portions may energize or not energize thereby giving the design the appearance of movement. In this manner the light panel can be designed to provide ornamental appearances that can change over a selected period of time or to give the appearance of movement. One such light panel is available from Flexmedia Canada, Inc., of Ontario Canada.

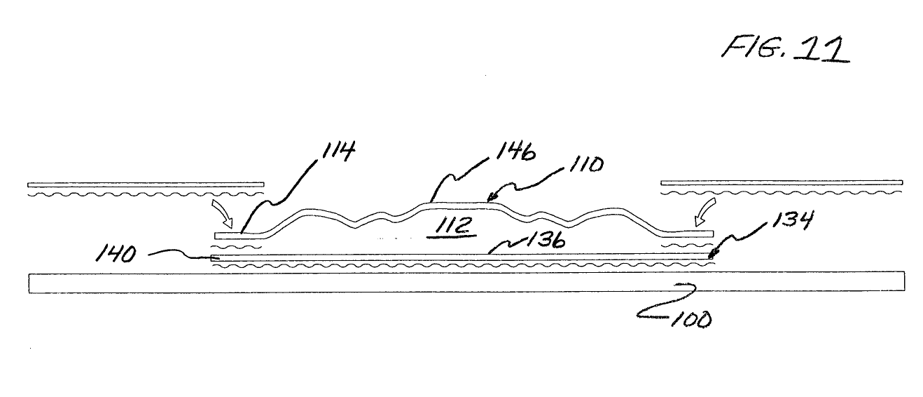

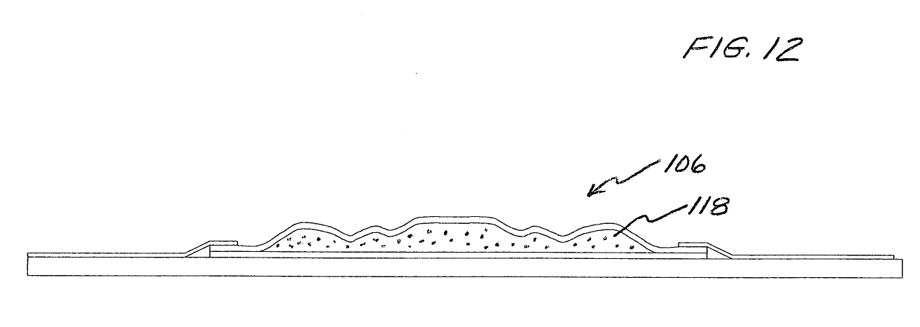

In another preferred embodiment, shown in FIGS. 11 and 12, of the invention the design element 106 comprises a three-dimensional shape comprising a first surface 110 raised and extending outwardly from the surface of the structure 100 forming a cavity 112 and having a periphery 114 extending around the raised first surface 110. Preferably, the design element 106 comprises a relatively thin, clear or translucent thermoplastic outer sheet 146 and decorated using paint or printing, that can be formed into a three-dimensional shape through the application of heat and pressure such as by conventional vacuum forming process. The cavity 112 can be unfilled or filled with a transparent plastic backing 118 (FIG. 12) for providing additional structural support to the design element 106. An electroluminescent light panel 134, such as described hereinabove, is mounted to the surface of the structure 100 such that its luminescent layer 140 generates illumination when excited by am electric current which then radiates outwardly through the light permeable electrode layer 136 and the translucent thermoplastic outer sheet 146.

In a preferred embodiment of the invention the design element 106 comprising an electroluminescent light panel 134 is electronically connected to the electrical system 148 of the structure such as by wires 150 (See FIG. 5). In another preferred embodiment of the invention, the electrical system 150 is a battery system.

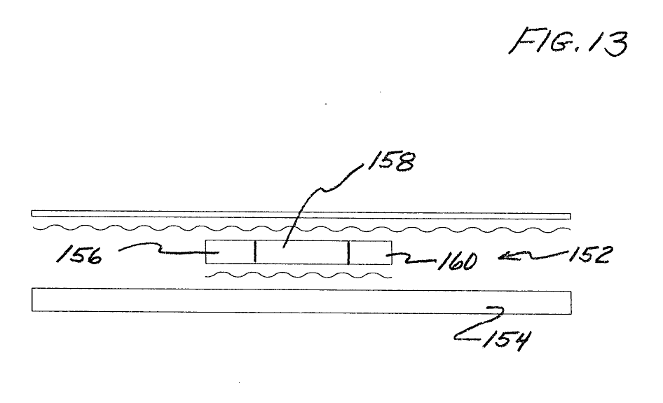

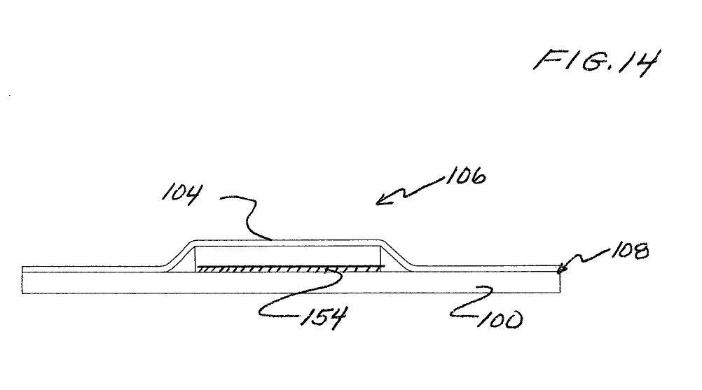

In another preferred embodiment of the invention, as shown in FIGS. 13 and 14, the design element 106 comprises a self-contained electronic sound-emitting device 152 for providing recorded sounds. As shown, the sound-emitting device 152 is attached to a substrate 154 for attaching to the surface 108 of the structure 100. The sound-emitting device 152 includes an electronic microchip 156 for recoding a playing a sound (such as those commonly used in recoding devices), an amplification module 158, and an activation device 160 for activating the electronic microchip 156. Preferably the sound-emitting device 152 is electrically coupled to the power source of the structure (not shown), such as by wires or the power source may be a battery or a microbattery held within the sound-emitting device 152. In a preferred embodiment of the invention the activation device 160 is a conventional motion detector that activates the electronic microchip 156 to play a sound, tone, or the like when motion of an object is detected within a predetermined proximity or activation zone of the structure. In another preferred embodiment, the activation device 160 is a timer that activates the microchip 156 at fixed or variable intervals of time.

In a preferred embodiment of the invention, the sound-emitting device 152 is directly attached to the surface 108 of the structure 100 or is attached to the inside surface of the background 104 of the wrap 102. In another preferred embodiment of the invention the sound-emitting device 152 is placed within the cavity 112 of the raised surface 110 of the design element 106 (FIGS. 3 and 11).

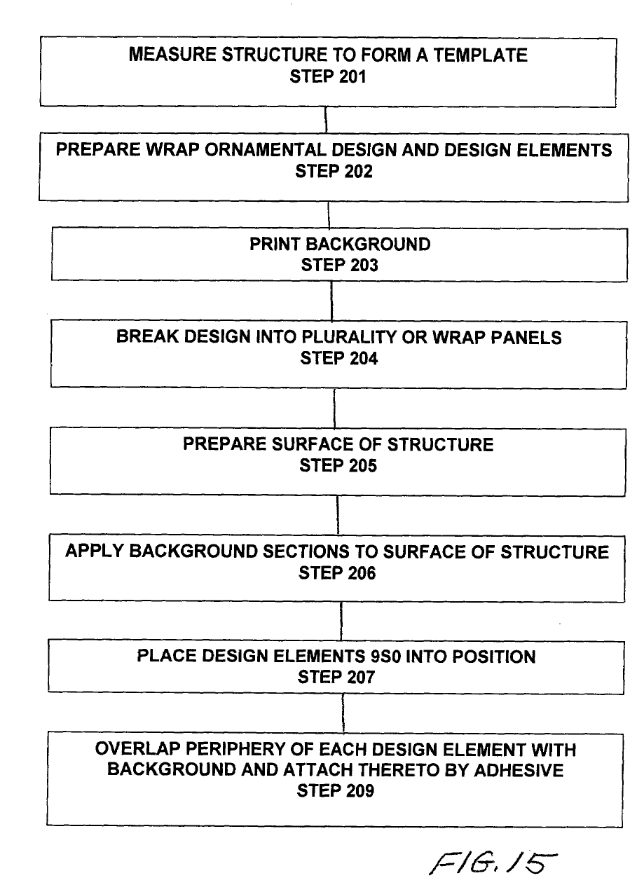

Referring to FIG. 15, a schematic representation of the general methodology of applying a wrap is illustrated. The method of wrapping the structure is carried out in a series of steps. In a first step 201, the structure is measured and its contour is examined to form a template. In the second step 202, a design is prepared for the wrap having an image (background and design elements) that is sized to properly fit onto the structure. The particular design elements, such as those having a three-dimensional character, lighted panels, and the like are selected. The background is then printed onto the wrap using conventional wrap printing processes and materials, step 203. The fourth step 204 of the process is breaking the design into a plurality of wrap panels such that when the wrap panels are applied to the structure they will fit together to form what appears to be a seamless image. In a fifth step 205, the surface of the structure to be wrapped is cleaned to ensure that the wrap adhesive will properly adhere without the risk of peeling. Typically, dust, dirt, salt and the like are removed using a water and soap solution. For an illustrative example, an automated car wash can be used for an automobile. Grease, oil, wax and other contaminants should be removed using a solvent, such as for example Sol or Xylol and finished using a solvent such as for example isopropyl alcohol to ensure that no residue of soap, solvents, and the like remain on the surface of the structure to be wrapped. After the surface has been cleaned of all contaminants, the background sections of the wrap are conventionally applied to the surface, step 206, of the structure leaving the periphery edges of the background surrounding the areas of the design elements free. The design elements, including those comprising three-dimensional design elements and/or comprising electroluminescent light panels and/or sound devices are then attached to the surface of the structure such as by an adhesive typically used for attaching a wrap to a substrate, step 207. The periphery edges of the background are then placed such that they overlap and substantially covers the peripheral of each design element and attached to the lower surface of the background by a suitable adhesive, step 208.

The structure and method of wrapping the structure of the subject invention provides a new and improved wrap that increasing the awareness and impact that the wrap will have on potential customers and creates a harmonized ornamental design. As described above, the structure and method of wrapping provides a weather resistant wrap that performs well when exposed to heat, cold, ultraviolet light and wind or air flow generated by the movement of the structure and which is capable of withstanding exposure to outside forces, such as car washes, inadvertent contact and the like. As described, the wrap can include three-dimensional design elements, electrolminescent lighting, sound elements, and/or combination thereof.

Although the foregoing invention has been described in some detail for purposes of clarity of understandings, it will be apparent that certain changes and modifications may be practiced within the scope of any claims. It should now be apparent that the various embodiments presented can be easily modified while keeping within the scope and spirit of the subject invention. Accordingly, it should be understood that the present disclosure is to be considered as exemplary of the principals of the invention and is not intended to limit the invention to the embodiments and the specific examples illustrated and the invention is not to be limited to the details given herein, but may be modified within the scope and equivalents of the descriptions and examples contained herein.

1. A wrap applied to the surface of a structure, the wrap comprising:
a background; and
at least one design element;
wherein said design element and said background cooperate together to create a harmonized ornamental design.

2. The wrap of claim 1 wherein said design element comprises at least one light panel.

3. A wrap applied to the surface of a structure, the wrap comprising:
a background; and
at least one design element, said design element having a first surface and a periphery extending around said first surface;
wherein said background overlaps and substantially covers said periphery of the first surface.

4. The wrap of claim 3 wherein said design element is comprises a three-dimensional shape wherein said first surface is raised and extends in a direction outwardly from the surface of the structure forming an inner cavity.

5. The wrap of claim 3 wherein said design element comprises an electrolminescent light panel.

6. The wrap of claim 3 wherein said design element comprises an electronic sound-emitting device for playing recorded sounds.

7. A wrap applied to the surface of a structure, the wrap comprising:
a background; and
a design element, wherein said design element is a three-dimensional design element extending in a direction outwardly from the surface of the structure.

8. The wrap of claim 7 wherein said design element is formed from a thermoplastic material.

9. The wrap of claim 7 wherein said design element includes a backing for providing structural support to the design element.

10. The wrap of claim 7 wherein said design element further comprises an electrolminescent light panel for providing background lighting to said design element.

11. The wrap of claim 7 wherein said design element further comprises an electronic sound-emitting device for playing recorded sounds.

12. The wrap of claim 11 wherein said sound-emitting device comprises an activation device having a motion detector that activates the sound-emitting device when motion of an object is detected within a predetermined proximity or activation zone of the structure.

13. The wrap of claim 11 wherein said sound-emitting device comprises an activation device comprising a timer that activates the sound-emitting device at a fixed or at variable intervals of time.

14. The wrap of claim 7 wherein said design element is attached to the structure such that the background provides a seal along the periphery of the design element.

15. A wrap for applying to the surface of a structure, the wrap comprising:
a background and one or more design elements applied along at least a portion of the surface of the structure;
wherein at least one design element comprises a raised surface extending in a direction outwardly from the surface forming an inner cavity and having a periphery extending around said raised surface;
wherein said wrap further comprises a backing effective for filling said cavity and providing support for said design element.

16. The wrap of claim 15 wherein said backing is a foam backing.

17. The wrap of claim 15 wherein said raised surface is formed from a thermoplastic material.

18. The wrap of claim 15 wherein said design element further comprises an electrolminescent light panel for providing background lighting to said design element.

19. The wrap of claim 15 wherein said design element further comprises an electronic sound-emitting device for playing recorded sounds.

20. The wrap of claim 19 wherein said sound-emitting device comprises an activation device having a motion detector that activates the sound-emitting device when motion of an object is detected within a predetermined proximity or activation zone of the structure.

21. The wrap of claim 19 wherein said sound-emitting device comprises an activation device comprising a timer that activates the sound-emitting device at a fixed or at variable intervals of time.

22. The wrap of claim 15 wherein said design element is attached to the structure such that the background overlaps at least a portion of said periphery extending around said first surface of said design element to form a seal.

23. A wrap applied to the surface of a structure, the wrap comprising:
a background; and
a design element, wherein said design element comprises an electrolminescent light panel.

24. The wrap of claim 23 wherein said design element further comprises an electronic sound-emitting device for playing recorded sounds.

25. The wrap of claim 24 wherein said sound-emitting device comprises an activation device having a motion detector that activates the sound-emitting device when motion of an object is detected within a predetermined proximity or activation zone of the structure.

26. The wrap of claim 23 wherein specific areas of said light panel can energize or not energize at preselected time intervals.

27. The wrap of claim 23 wherein said light panel having a design thereon that said operation of said light panel gives the design the appearance of movement.

28. The wrap of claim 25 wherein said sound-emitting device comprises an activation device comprising a timer that activates the sound-emitting device at a fixed or at variable intervals of time.

29. The wrap of claim 24 wherein said design element is attached to the structure such that the background overlaps at least a portion of said periphery extending around said first surface of said design element to form a seal.

30. A method of installing a wrap on a structure comprising the steps of:
measuring the structure to form a template;
preparing a design having an image that is sized to properly fit onto the structure;
printing a design on the background forming the wrap
attaching the background of the wrap to the surface of the structure;
attaching the design elements to the structure and overlapping the background along the periphery of the design elements to form a seal around the periphery of the design elements.

31. The method of claim 30 wherein said design element is a three-dimension design element.

32. The method of claim 31 wherein the three-dimensional design element is formed using a vacuum forming process.

33. The method of claim 30 wherein said design element comprises an electrolminescent light panel.
